(19) United States
(12) Patent Application Publication
(10) Pub. No.: US 2025/0392062 A1
(43) Pub. Date: Dec. 25, 2025

(54) Terminal Block

(71) Applicant: Tyco Electronics AMP Korea Co., Ltd., Gyeongsan (KR)

(72) Inventors: Byung-Hee Cho, Gyeongsan-Si (KR); Sung-Chul Kim, Gyeongsan-Si (KR)

(73) Assignee: Tyco Electronics AMP Korea Co., Ltd., Gyeongsan (KR)

(21) Appl. No.: 19/244,433

(22) Filed: Jun. 20, 2025

(30) Foreign Application Priority Data
Jun. 20, 2024 (KR) 10-2024-0080180
Jun. 21, 2024 (KR) 30-2024-0024472
Jun. 21, 2024 (KR) 30-2024-0024473
May 29, 2025 (KR) 10-2025-0070495

(51) Int. Cl. H01R 9/24; H01R 9/18

(52) U.S. Cl. CPC H01R 9/2416; H01R 9/18

(57) ABSTRACT

A terminal block includes a block housing, a holder assembly provided to be vertically movable in the block housing, a nut member passing through an inner side of the holder assembly and securely installed in the block housing, and an elastic member provided in the block housing and elastically supporting the holder assembly. The holder assembly includes a holder terminal and a securing member configured to secure a plate terminal. The holder terminal is integrally formed with a retainer ring that prevents the securing member from being detached from the holder terminal.

### CROSS-REFERENCE TO RELATED APPLICATION

This application claims the benefit of the filing date under 35 U.S.C. § 119 (a)-(d) of Korean Patent Application No. 10-2024-0080180, filed on Jun. 20, 2024, Korean Patent Application No. 10-2025-0070495, filed on May 29, 2025, Korean Patent Application No. 30-2024-0024473, filed on Jun. 21, 2024, and Korean Patent Application No. 30-2024-0024472, filed on Jun. 21, 2024.

### FIELD OF THE INVENTION

One or more embodiments relate to a terminal block capable of preventing the detachment of a securing member that secures a plate terminal.

### BACKGROUND OF THE INVENTION

In conventional devices such as ovens or dryers, terminal blocks are used for assembling plate terminals. Terminal blocks utilize securing members such as screws or bolts to secure plate terminals. Generally, when securing a plate terminal to a terminal block, a worker uses hand tools such as a screwdriver. While the worker is working on such a task, there is a possibility of losing a securing member. When a securing member is lost and a non-standard securing member is used, the plate terminal may not be firmly secured because the securing member fails to meet standards. As a result, there is a risk of incidents such as fires.

### SUMMARY OF THE INVENTION

A terminal block includes a block housing, a holder assembly provided to be vertically movable in the block housing, a nut member passing through an inner side of the holder assembly and securely installed in the block housing, and an elastic member provided in the block housing and elastically supporting the holder assembly. The holder assembly includes a holder terminal and a securing member configured to secure a plate terminal. The holder terminal is integrally formed with a retainer ring that prevents the securing member from being detached from the holder terminal.

### BRIEF DESCRIPTION OF THE DRAWINGS

Aspects, features, and advantages of the invention will become apparent and more readily appreciated from the following description of embodiments, taken in conjunction with the accompanying drawings of which:

FIG. 1 is a perspective view of a terminal block according to an embodiment;

FIG. 2 is a cross-sectional view taken along line II-II of the terminal block in FIG. 1;

FIG. 3 is an exploded perspective view of the terminal block in FIG. 1;

FIG. 4A is a perspective view of a plate terminal according to an embodiment;

FIG. 4B is a perspective view of a plate terminal according to another embodiment;

FIG. 5A is a perspective view of a block housing according to an embodiment;

FIG. 5B is a plan view of the block housing of FIG. 5A;

FIG. 6 is a perspective view of a holder assembly according to an embodiment;

FIG. 7A is a top perspective view of a nut member according to an embodiment; and

FIG. 7B is a bottom perspective view of the nut member of FIG. 7A.

### DETAILED DESCRIPTION

Embodiments provide a terminal block capable of preventing the loss of a securing member used for securing a plate terminal.

The technical aspects obtainable from the present disclosure are non-limited by the above-mentioned technical aspects, and other unmentioned technical aspects may be clearly understood from the following description by those having ordinary skill in the technical field to which the present disclosure pertains.

Hereinafter, embodiments are described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly to another component, and an intervening component may also be “connected,” “coupled,” or “attached” to the components.

The same name may be used to describe an element included in the embodiments described above and an element having a common function. Unless stated otherwise, the configuration described in any one embodiment may be applied to other embodiments, and repeated descriptions will be omitted.

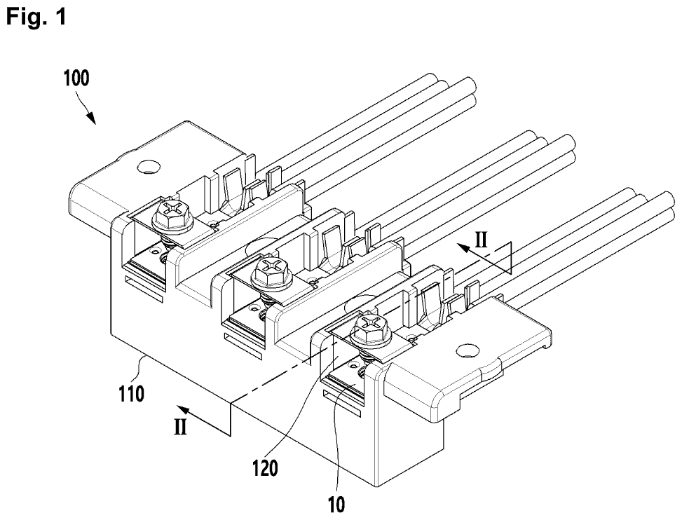

Hereinafter, a terminal block 100 is described with reference to FIGS. 1 to 7B. The terminal block 100 may include a plate terminal 10, a block housing 110, a holder assembly 120, a nut member 130, and an elastic member 140.

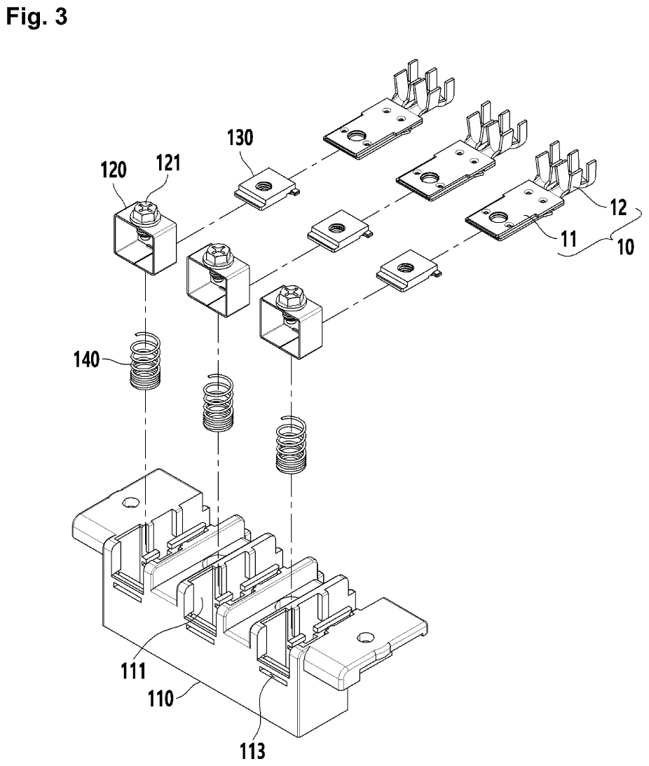

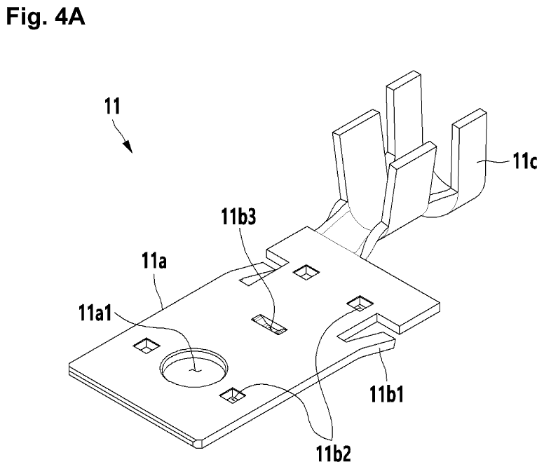

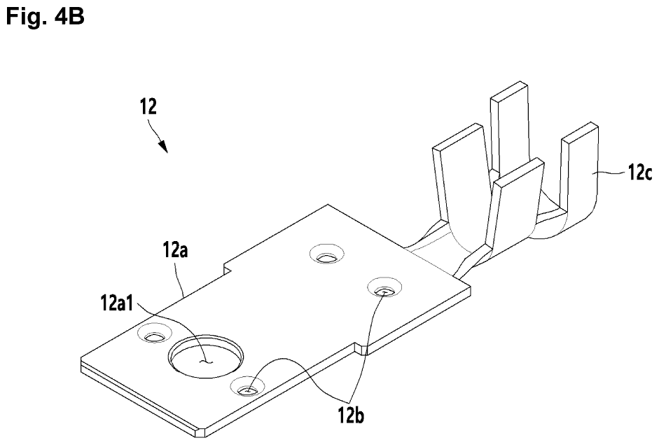

The plate terminal 10 may include two terminals that may be secured together, as shown in FIG. 3. A first terminal 11 and a second terminal 12, as shown in FIGS. 4A and 4B, may include plate-shaped head portions 11a and 12a, which have through holes 11a1 and 12al for securing a securing member 121, and barrel portions 11c and 12c to which wires are secured. Here, although the first terminal 11 and the second terminal 12 may be formed in similar shapes such that the first terminal 11 and the second terminal 12 may overlap each other, there are slight differences in the structure for coupling the first terminal 11 and the second terminal 12 together and in the positions of the barrel portions 11c and 12c.

The barrel portions 11c and 12c may be formed in positions biased to the left and right, respectively, relative to the centerline of each of the head portions 11a and 12a so that no interference occurs when the first terminal 11 and the second terminal 12 are coupled together by overlapping each other. For example, as illustrated in FIG. 4A, the barrel portion 11c of the first terminal 11 may be formed on the left of the first terminal 11, and as illustrated in FIG. 4B, the barrel portion 12c of the second terminal 12 may be formed on the right of the second terminal 12.

In the structure for coupling the first terminal 11 and the second terminal 12 together, as a portion of the edge of the head portion 11a of the first terminal 11 is cut, a locking tongue portion 11b1 that is bent relative to a plane of the head portion 11a may be formed. In addition, a plurality of locking holes 11b2 and locking bosses 12b that correspond to one another may be formed on the first terminal 11 and the second terminal 12, respectively. In other words, the second terminal 12 has the locking bosses 12b that protrude toward the first terminal 11 on the surface that is in contact with the first terminal 11, and the locking bosses 12b may be inserted into the locking holes 11b2 of the first terminal 11, thereby securing the first terminal 11 and the second terminal 12 together. Additionally, a dimple 11b3 may be formed on the first terminal 11 to prevent the position of the first terminal 11 from deviating in relation to the securing member 121.

The diagrams are for ease of description, and the shapes of the first terminal 11 and the second terminal 12 are not limited to the drawings. In addition, the structure for coupling the first terminal 11 and the second terminal 12 together is also not limited to the diagrams, and some structures may be omitted.

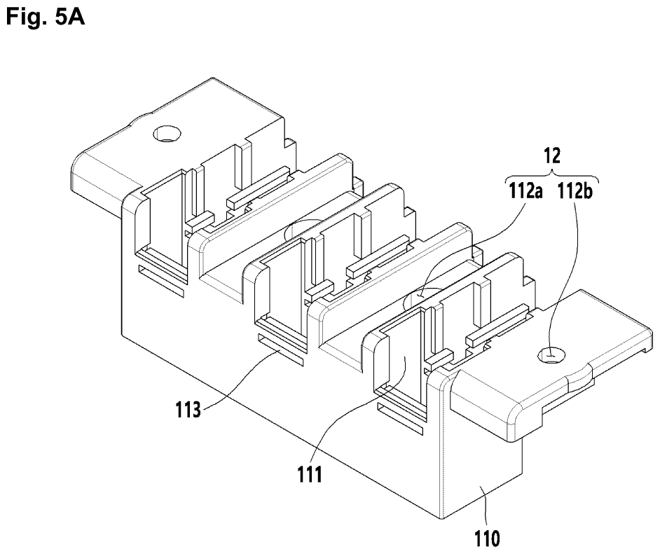

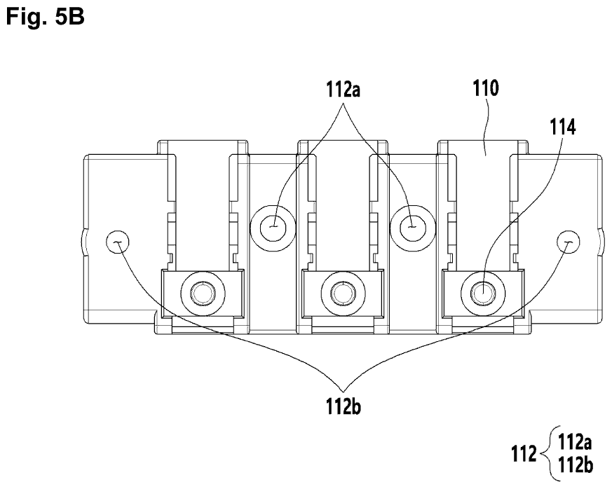

The block housing 110 may be formed so that the plate terminal 10 and the holder assembly 120 may be mounted. For example, the block housing 110 may include a plurality of seating grooves 111 to which a plurality of holder assemblies 120 are mounted. Each seating groove 111 may be partitioned to independently accommodate each holder assembly 120. Additionally, the block housing 110 may include a window 113. When the nut member 130 is assembled to the block housing 110, its assembled state may be checked through the window 113. Moreover, the block housing 110 may include a mounting hole 112 so that the block housing 110 may be mounted to a device such as an oven and the like. For example, the block housing 110 may include a plurality of mounting holes 112a and 112b (see FIG. 5B) at different positions or intervals so that the block housing 110 may be mounted to various devices such as an oven or a dryer. However, the diagrams are for ease of description, and the shape of the block housing 110 is not limited to the diagrams.

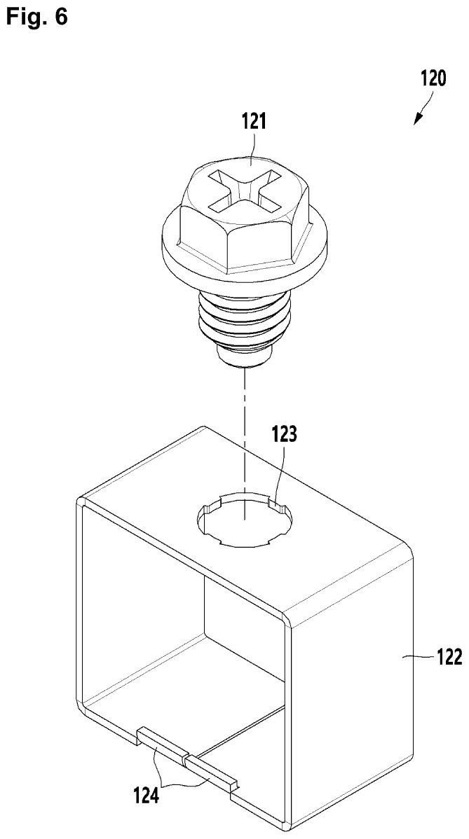

The holder assembly 120, as shown in FIG. 6, may include a holder terminal 122 and the securing member 121 that secures the plate terminal 10 to the holder terminal 122. The holder terminal 122 may have a quadrangular ring frame shape. A retainer ring 123 may be integrally formed with a hole through which the securing member 121 passes on the upper surface of the holder terminal 122. The retainer ring 123 may secure the securing member 121 to prevent the securing member 121 from detaching from the holder terminal 122. The retainer ring 123 may allow the securing member 121 to rotate so that the securing member 121 may be fastened to the nut member 130. For example, a plurality of protrusions may protrude inwardly from the retainer ring 123 and may be in contact with the outer circumferential surface of the securing member 121 to prevent the detachment of the securing member 121.

According to this embodiment, since the retainer ring 123 is integrally formed with the holder terminal 122, no additional structure may be required to secure the securing member 121, thereby reducing the number of components and cost.

Additionally, the holder terminal 122 may include a stopper 124 protruding inwardly from the holder terminal 122 (i.e., protruding upward from the bottom surface of the holder terminal 122). The stopper 124 may be coupled to the nut member 130 to prevent the holder terminal 122 from moving back and forth relative to the nut member 130, thereby avoiding misalignment.

Additionally, the size of the holder terminal 122 (the length between the upper and lower surfaces of the holder terminal 122) may be formed to be greater than the length of the securing member 121. In other words, the lower end of the securing member 121, which extends inwardly through the holder terminal 122, may be formed not to be in contact with the nut member 130 and the plate terminal 10 installed in the holder terminal 122.

The nut member 130 may pass through the inner side of the holder terminal 122 and may be installed in the block housing 110. The nut member 130 may have a shape corresponding to the head portions 11a and 12a of the plate terminal 10 so that the plate terminal 10 may be mounted on the upper surface of the nut member 130.

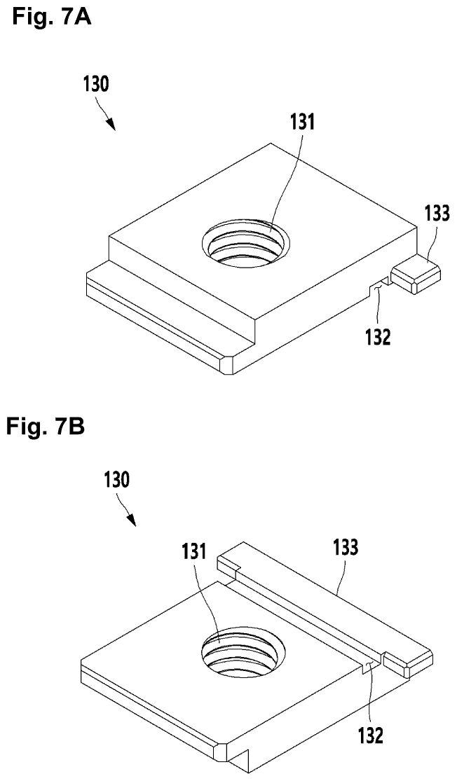

A fastening hole 131 to which the securing member 12 is fastened may be formed on one side of the nut member 130. A protruding portion 133 that is secured to the block housing 110 may be formed on one edge of the nut member 130, as shown in FIGS. 7A and 7B. For example, the protruding portion 133 may protrude outwardly from the nut member 130. Additionally, a locking groove 132 into which the stopper 124 of the holder terminal 122 is fitted may be formed on the other side of the nut member 130. Furthermore, the nut member 130 may be formed so that the other edge opposite to the edge where the protruding portion 133 is formed fits into the window 113 of the block housing 110. In the diagrams, the thickness of the other edge of the nut member 130 is illustrated as being thin, but this is merely an example, and the overall thickness of the nut member 130 may be formed to be uniform.

The elastic member 140 may be installed inside the seating groove 111 of the block housing 110 and may elastically support the holder assembly 120 from below. Here, an installation boss 114 (see FIG. 5B) into which the elastic member 140 is fitted can be formed on the inner bottom surface of the seating groove 111.

The assembly process of the terminal block 100 is described.

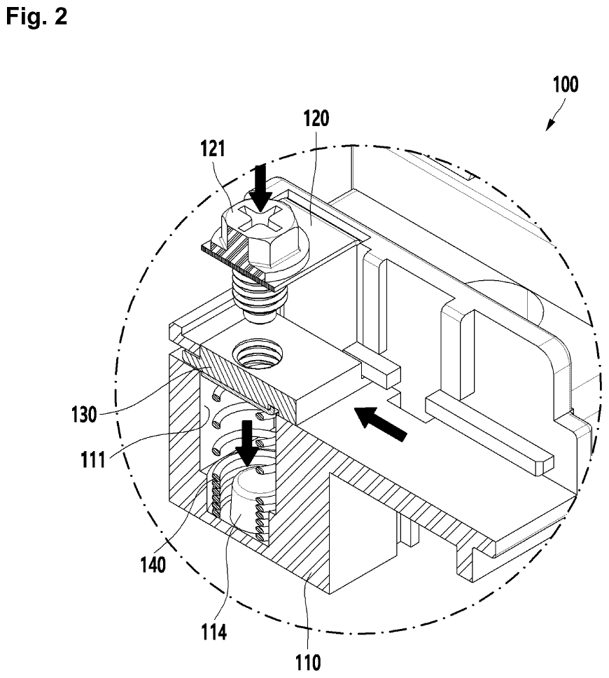

First, the elastic member 140 may be installed to fit into the installation boss 114 in the seating groove 111 of the block housing 110, as shown in FIG. 2.

Next, the holder assembly 120 may be installed in the seating groove 111 so as to be supported on the elastic member 140. Here, the holder terminal 122 may not be secured to the block housing 110 but may be installed to move vertically in the seating groove 111.

Then, the nut member 130 may be installed by passing through the holder terminal 122. The protruding portion 133 of the nut member 130 may be secured to the block housing 110, and the stopper 124 of the holder terminal 122 may be fitted into the locking groove 132.

As the nut member 130 is installed in this manner, the vertical movement of the holder assembly 120 may be restricted by the nut member 130, and the forward and backward movement of the holder assembly 120 may also be restricted by the nut member 130.

Next, the plate terminal 10 may be installed on the nut member 130, and the securing member 121 may be fastened to the nut member 130 by passing through the plate terminal 10. Here, since the holder terminal 122 is elastically supported by the elastic member 140, the securing member 121 may be pressed down to be fastened to the nut member 130.

According to these embodiments, since the securing member 121 for securing the plate terminal 10 is provided in the holder assembly 120, there may be no risk of losing the securing member 121 during the process of securing the plate terminal 10, thereby improving the assembly work efficiency of the terminal block 100 and reducing costs.

In addition, as the plate terminal 10 is formed by two members 11, 12 in a structure in which the two members are coupled together, a state in which terminals 11, 12 are coupled together may be maintained, a terminal assembly process may be simplified, and workability may be improved.

While the embodiments have been described with reference to the limited drawings, it will be apparent to one of ordinary skill in the art that various alterations and modifications can be made from the above description. For example, suitable results may be achieved if the described techniques are performed in a different order, and/or if components in a described system, architecture, device, or circuit are combined in a different manner, or replaced or supplemented by other components or their equivalents. Therefore, other implementations, other embodiments, and equivalents to the claims are also within the scope of the following claims.

1. A terminal block, comprising:
a block housing;
a holder assembly provided to be vertically movable in the block housing, the holder assembly includes a holder terminal and a securing member configured to secure a plate terminal, the holder terminal is integrally formed with a retainer ring that prevents the securing member from being detached from the holder terminal;
a nut member passing through an inner side of the holder assembly and securely installed in the block housing; and
an elastic member provided in the block housing and elastically supporting the holder assembly.

2. The terminal block of claim 1, wherein the holder terminal has a quadrangular ring frame shape and has an upper surface on which the retainer ring is integrally formed.

3. The terminal block of claim 2, wherein a distance between an upper surface and a lower surface of the holder terminal is greater than a length of the securing member extending inwardly through the holder terminal.

4. The terminal block of claim 2, wherein the holder terminal has a stopper protruding inwardly from a lower surface of the holder terminal.

5. The terminal block of claim 4, wherein a locking groove of the nut member is fitted onto the stopper to restrict movement of the holder terminal.

6. The terminal block of claim 1, wherein an edge of the nut member has a protruding portion fastenable to the block housing.

7. The terminal block of claim 1, wherein the block housing has a seating groove, the holder assembly is mounted in the seating groove.

8. The terminal block of claim 7, wherein the elastic member is disposed on a bottom of the holder assembly in the seating groove.

9. The terminal block of claim 7, wherein the block housing has a window.

10. The terminal block of claim 9, wherein the nut member installed in the seating groove is visible through the window.

11. The terminal block of claim 1, wherein the plate terminal has a first terminal and a second terminal.

12. The terminal block of claim 11, wherein the first terminal and the second terminal are coupled together by overlapping each other on the nut member.

13. The terminal block of claim 12, wherein each of the first terminal and the second terminal has a plate-shaped head portion and a barrel portion to which a wire is coupled.

14. The terminal block of claim 13, wherein the barrel portion of the first terminal and the barrel portion of the second terminal are biased with respect to a centerline of the first terminal and the second terminal.

15. The terminal block of claim 14, wherein the barrel portion of the first terminal does not interfere with the barrel portion of the second terminal when the first terminal and the second terminal are coupled together.

16. The terminal block of claim 13, wherein the plate-shaped head portion of each of the first terminal and the second terminal has a through hole receiving the securing member.

17. The terminal block of claim 16, wherein the first terminal has a locking tongue portion bent relative to a plane of the plate-shaped head portion and a plurality of locking holes.

18. The terminal block of claim 17, wherein the second terminal has a plurality of locking bosses protruding toward the first terminal and received in the locking holes.
